(19) United States
(12) Patent Application Publication
(10) Pub. No.: US 2008/0244418 A1
(43) Pub. Date: Oct. 2, 2008

(54) DISTRIBUTED MULTI-PARTY SOFTWARE CONSTRUCTION FOR A COLLABORATIVE WORK ENVIRONMENT

(75) Inventors: Dragos A. Manolescu, Kirkland, WA (US); Rajesh K. Hegde, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/838,673

(22) Filed: Aug. 14, 2007

Related U.S. Application Data
(60) Provisional application No. 60/920,930, filed on Mar. 30, 2007.

(51) Int. Cl. G06F 9/44; G06F 15/16; G06F 3/048

(52) U.S. Cl. 715/753; 717/100

(57) ABSTRACT

The disclosed architecture extends the traditional integrated design environment (IDE) designed for solo development work with features and capabilities that support collaborative distributed work (e.g., distributed pair programming). The architecture provides integrated communication channels that enable the participants to engage in collaborative work. The graphical user interface capabilities are also extended with distributed functionality specific to multi-party (e.g., pair) programming, including, but not limited to manual and/or automatic role control and turn-taking, multiple cursors (destructive and non-destructive), remote highlighting, decaying edit trail, easy access to history of edits, language-independent event model and, view convergence and divergence. The system uses the collaboration and communication patterns and information to identify problems, extract metrics, make recommendations, etc.

### CROSS-REFERENCE TO RELATED APPLICATIONS

This application claims the benefit of U.S. Provisional Patent application Ser. No. 60/920,930 entitled “DISTRIBUTED MULTI-PARTY SOFTWARE DEVELOPMENT SUPPORT FOR AN INTEGRATED DEVELOPMENT ENVIRONMENT” and filed Mar. 30, 2007, the entirety of which is incorporated by reference.

### BACKGROUND

Collaborative development represents an increasingly popular trend in software construction. One of its most common instantiations, pair programming is a practice in which two programmers work together at one computer, sharing the same integrated development environment (IDE), computer keyboard and mouse collaborating on the same software development problem (e.g., design, algorithm, code, test or even document). Studies have shown that pair programmers can produce code with a reduced defect rate in essentially the same amount of time as solo programmers. Additional benefits include increased job satisfaction, improved team communication, and efficient tacit knowledge sharing.

Although at first sight pair programming seems to misuse developer bandwidth, research has shown that it provides benefits. The division of responsibilities in pair programming increases the code quality and overall productivity; also because the development team is sharply focused the defect rate is reduced. A large number of companies embrace pair programming. While the benefits of pair programming are not universally agreed upon, empirical studies indicate that pair programming: is suitable for projects where the short time to market is critical, increases development velocity and decreases the number of defects, and facilitates developer's working on complex tasks.

Another recent trend is distributed software development. Distributed development employs world-wide talent to build software. Teams no longer have to reside at one location; networked computers rendered geographical location obsolete. Probably one of the main incentives to adopting distributed development stems from the economic implications. While programming skills are distributed more or less evenly, there is a wide variance in the cost of living. Consequently spreading software development between areas where there are significant differences in the cost of living has traditionally lowered the cost. Another incentive stems from time differences. Teams distributed across several time zones can theoretically work around the clock. As the work day ends in one time zone, a team located in a different time zone could start.

While pair programming is shown to have benefits, it may not always be possible for all team members to be collocated due to the rise in teleworking and geographically distributed teams. This creates the need to extend the collocated pair programming model to a distributed model where collaborators can be geographically separated, but can work together on the same project while enjoying all the benefits of the traditional pair programming. Consequently as pair programming and distributed development are becoming increasingly the norm developers find themselves forced to marry the two. However, current IDEs provide little assistance in solving this problem, if at all, because the IDEs were designed under assumptions that no longer hold (such as collocated teams, contributors having their own workstation and working individually). In particular, the large majority of IDE features cater to programmers developing alone and working at a single workstation.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture extends the traditional integrated development environment (IDE) designed for solo development work with features and capabilities designed for collaborative, distributed software construction (e.g., distributed pair programming). The user experience and graphical user interface capabilities are also extended with functionality specific to collaborative work (e.g., pair programming), including, but not limited to, manual and/or automatic role control and turn-taking, multiple cursors (destructive and non-destructive), multi-party highlighting, navigation, annotation, decaying edit trail (e.g., time-based or change-based), access to history of edits, language-independent event model and, view convergence and divergence.

The architecture provides multiple different communications channels into the collaborative environment such as text messaging, code review, application sharing, audio channels, video channels, instant messaging, and so on.

Presence information is generated and provided related to users that may be online (or offline) and which, when selected can engage the collaborative environment (or session) via one or more of the different communications channels. For example, when a first user desires to initiate a pair or multi-party programming session, the architecture automatically generates and presents the presence information of one or more other users to the first user about the availability (e.g., online, offline, away, editing, debugging, etc.) of the one or more other users. The first user can then select a second user via the presence information and the session can begin. The presence information can be realtime, contextual, and/or inferred, for example.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented system for collaborative, multi-party distributed software construction.

FIG. 2 illustrates an alternative embodiment of a system that includes additional capabilities to the system of FIG. 1.

FIG. 3 illustrates an implementation of an exemplary system in the context of a collaboration environment.

FIG. 4 illustrates a computer-implemented method of multi-party software construction.

FIG. 5 illustrates a method of employing visual cues in a collaborative environment for software construction.

FIG. 6 illustrates a method of processing presence information for collaboration participants.

FIG. 7 illustrates a method of connecting to session users for presence determination.

FIG. 8 shows a screenshot for code review within a collaborative software construction environment.

FIG. 9 shows a screenshot of presence information.

FIG. 10 shows a screenshot for establishing communications with a user, and a collaboration feature being only one click away, as well as text, chat, and audio/video actions.

FIG. 11 shows a screenshot of a communications chat session as well as audio/video communications between the session participants.

FIG. 12 illustrates a block diagram of a computing system operable to execute collaborative software construction in accordance with the disclosed architecture.

FIG. 13 illustrates a schematic block diagram of an exemplary computing environment for collaborative programming.

### DETAILED DESCRIPTION

Combining collaborative support such as features required for pair programming with distributed development is a challenging proposition. The two opposing forces are that pair programming requires that developers physically share a workstation and engage in verbal and non-verbal communication (e.g., eye contact, facial expressions, posture, and gestures), while distributed development revolves around dispersing developers into different geographical areas, and employing low-bandwidth communication channels such as instant messaging (IM), and/or general-purpose communication channels that are not integrated with the environment, such as phones.

The disclosed architecture extends the conventional integrated development environment (IDE) metaphor designed for solo development work, with features designed for collaborative, distributed software construction (e.g., development, programming, editing, testing, modeling, debugging, etc.) such as distributed pair programming and collaborative reviews. The extensions enhance the software construction experience when the collaboration takes place between distributed as well as collocated parties.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

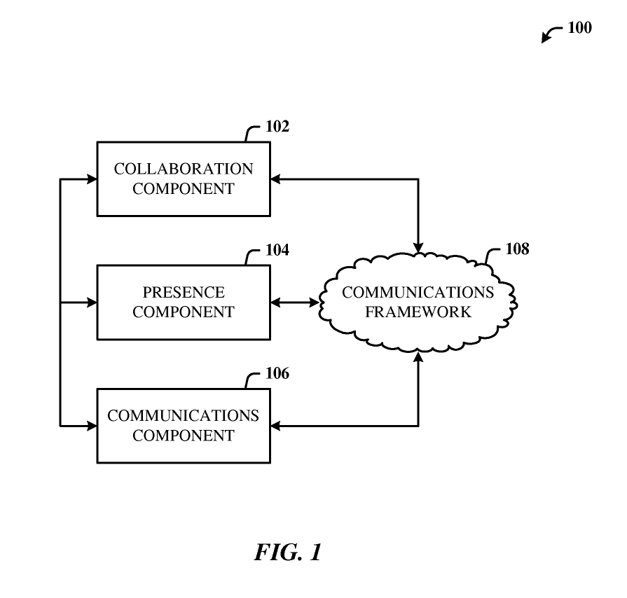

Referring initially to the drawings, FIG. 1 illustrates a computer-implemented system 100 for collaborative, multi-party distributed software construction. A collaboration component 102 is provided for generating or establishing a collaboration environment in which to perform collaborative software construction. A presence component 104 generates presence information related to availability of a user to participate in the collaborative environment. A communications component 106 of the system 100 provides multiple different communications channels (or mechanisms) by which the user (or users) can connect and participate in the collaboration environment.

The communications component 106 provides a unified communications mechanism for realtime interaction of participant computing systems, devices, and users. For example, the systems and devices can include desktop computers, portable computers, cell phones, landline handsets, PDAs, and the like. The ways in which users can communicate include conventional means such as chat, text messaging, audio communications, video communications, code review, application sharing, and so on. The system 100 is facilitated by a communications framework 108 that includes IP networks (e.g., the Internet, enterprise networks, etc.), cellular networks, wireless networks, and unlicensed wireless networks, for example.

The system 100 extends the traditional IDE designed for solo development work with features aimed at distributed pair programming. The features include a unified communications channel (e.g., text messaging, audio, video, etc.), a graphical user interface (GUI) with specific of pair programming features such as for automatic role control and turn-taking, multiple cursors (e.g., destructive and non-destructive), remote highlighting, decayed edit trail, convenient access to a history of edits, a language-independent event model and, view convergence and divergence, for example. Each of these will be described in more detail infra.

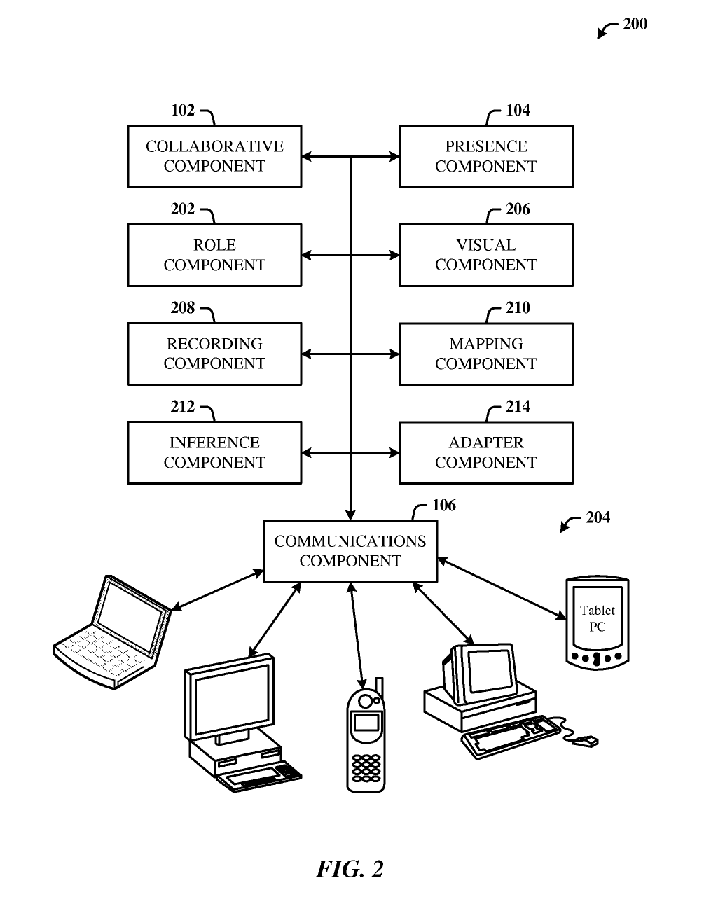

FIG. 2 illustrates an alternative embodiment of a system 200 that includes additional capabilities to the system 100 of FIG. 1. The system 200 also includes a role component 202 for switching roles (e.g., driver and navigator(s) in the context of pair programming) between the multiple participants participating via system and devices 204 during a programming activity, for example, of the collaborative environment established by the collaboration component 102. The roles can be configured to be switched manually and/or automatically. Role switching can occur automatically based on the type of connection (e.g., bandwidth), the participant's skills (e.g., experienced versus inexperienced navigators), the devices with which the participant navigators connect, time zones, and so on.

Role switching can be time based, for example, such that the role between the driver and the navigating automatically switches based on a preset-time (e.g., every thirty minutes). Alternatively, or in combination therewith, role switching can be performed manually by either the driver or the navigator selecting an option that switches the roles. Moreover, the system 200 can be configured to allow manual override of the automatic setting, or the automatic settings can be locked to prevent manual override. Role switching can also be managed only from the driver. That is, the roles will be switched only when the driver initiates role switching. Role switching can also be based on other triggers such as the gestures, physical or otherwise, that can be captured and processed by the local computing system and communicated to the role component 202.

The criteria employed for role switching can be numerous, and further enabled or managed via rules and/or policies. For example, a more experienced navigator, soon to be driver, can be automatically weighted with more time during the role-switching process, whereas the other participant (e.g., in pair programming) can be weighted with less time based on less experience. In a training or tutorial implementation, for example, the weighting can be reversed such that the driver/learner gets more time and the teacher/navigator gets less time.

Rules and policies can be imposed such that participants are regulated based on corporate hierarchy, group hierarchy, network permissions, etc. For example, a visiting intern will not be allowed to view or participate, or the intern will be limited on what can be viewed on the intern machine or device based on a rule. Polices can be imposed at any time for execution for collaborative sessions that are made corporate wide, group wide, or at the user level, for example. In other words, the flexibility provided via rules and/or polices are extensive for managing collaborative sessions in accordance with the disclosed software construction architecture.

The multiple computing systems and devices 204 can include collocated systems and/or distributed systems. The multiple computing systems 204 can connect according to peer-to-peer arrangement or through an intermediate server. In other words, the system 200 supports a distributed framework where system users can connect to the collaborative (e.g., programming) environment via the communications component 106 from essentially any location that provides network connectivity (e.g., wired or wireless). In a more specific implementation, no longer is it a requirement that participants be collocated in order to perform pair programming.

The system 200 also includes a visual component 206 for processing and presenting visual cues related to the programming activity, editing activity, debugging activity, and any other collaboration activity. For example, a navigator (reviewer) can be presented with a cursor that tracks driver activity, bolded window borders that surround the activity of the driver, audio cues (e.g., beeps, tones, music, participant voice, etc.) associated with driver/navigator activities, video cues (e.g., graphical animations, linked video clips, etc.), textual cues (e.g., pop-up messages from participants, Help messages, hints code, etc.), or other graphical and/or multimedia cues when viewing driver/navigator activity. In other words, it can be made possible for the driver to view navigator activity or responses to driver activity through many types of visual cues.

The visual component 206 also facilitates divergence and convergence of users. In other words, convergence locks the driver and navigator view such that the corresponding editors can be synchronized to show the same content. When the driver is working on an artifact (e.g., writing some piece of code), the screens are “locked” so only the driver is in control, and the navigator is restricted to perceiving exactly the same activity and content. In a divergent mode, a participant (e.g., a navigator) can leave the main session to interact with another user or the driver in a side collaborative session. For example, the navigator can choose to read a comment elsewhere, or to lookup the definition of a word, method, function, or some class, or work on a different artifact in another application. In one implementation, when the navigator works on other matters, the user is no longer associated with navigator functionality (the user leaves the session). The navigator is allowed to diverge and come back later to look at the current driver view. This is a nondestructive diverse view.

The navigator can do other things while in watching (or passive) mode. While the driver has control entering or editing program code, the navigator can access other controls that are nondestructive. For example, the navigator can move a control on the navigator system which is then presented as a cursor or other type of understandable graphic. The control can then be configured to be presented simultaneously on the driver system via the driver GUI as well, as a pointing indicator. Thus, both the driver and navigator can view the same visual cue as a means of enhancing the collaborative experience, for example. Although described in the context of a single navigator (in the singular), it is to be understood that the disclosed architecture supports multiple navigators each interacting with the visual cues in the same or different manner. The destructive/nondestructive interaction and capability is not limited to code, but can also apply to regular text, graphics, widgets, icons and any other artifacts, for example.

The distributed highlighting capability is similar to the nondestructive cursor control; however, now, the navigator(s) can mark up an area as a means for tagging a portion of the viewed content, for example, a set of controls to which the driver attention is to be directed. The marked up area is not restricted to text and could cover an arbitrary set of elements in the view.

In another example, a navigator can draw or circumscribe a GUI object (e.g., text, graphic) that will then appear, for example, as a translucent colored area or a thick rounded rectangle in a color that catches or alerts the viewer attention to that area. The highlighting provides an indication to the driver via the driver GUI that certain object that has been tagged by the navigator(s) is an area or object of interest to which the driver's attention should be directed.

It can also be a provided capability that the navigator(s) each can configure corresponding GUI to allow customized visual cues such as highlighting, etc. In other words, in a multi-party session of three or more computing systems, each of the navigators can be identified according to unique visual cues, other than textual cues. For example, a first navigator can be identified by the driver with a square pointer in the driver GUI while a second navigator can be identified with a circle pointer. Similar customization applies to highlighting (e.g., different colors for different navigators) or other types of visual cues (e.g., underling, bolding, italicizing, bracketing, etc.). These can be configured manually by the navigator, or automatically imposed as the navigators enter the session.

It can also be configured that the input of multiple navigators will only be presented to the driver, but not to other navigators, thereby providing a privacy exchange between the driver and any given navigator.

The use of the time decaying editing trail is useful for maintaining an efficient and productive session. This is related to interruptions that people are subjected to when in a multi-party session rather than when working alone. The decaying edit trail is a visual cue for a multi-party session such that when the driver makes a change, for example, the most-recently changed artifacts or code are emphasized in a way that fades with the “age” of the change.

In one implementation, as a user looks at the history of activities, the most frequent change will show more prominently compared to a second most recent change, which will be presented less prominently, and so on. Thus, an interrupted user can direct attention back to the session GUI and quickly catch up to the more recent activities of the driver and the activities of other drivers without causing additional interruptions to the ongoing session.

Accordingly, the visual cues facilitated by the visual component 206 can be configured in many different ways to indicate many different activities from the many different session participants. The visual cues for the decaying edit trail degrade (e.g., time-based or change-based) and the granularity can be configured from a single character to paragraphs and page, to objects and graphics, for example. If code is being examined, the visual cue can be configured to work only in conjunction with functions or classes, or show just files, for example. It can also be configured where the visual cue includes adjusting the background of the object or text, such that the background decays back to a normal (or default) setting. Additionally, the driver can select to not see the decaying activity that is presented to the navigators or only selected navigators.

The decaying edit trail functionality can also be carried through to the next driver or navigator so that the transition of moving between the navigator and driver will not result in loss of that information. In other words, this information can be cached and imposed as needed after the transition. As indicated herein, the decay can be time-based. Additionally, the decay can be change-based such as using a decaying highlighting for a configurable number of most recent changes, regardless of the clock time.

The system 200 can also include a recording component 208 for recording some or all session (collaborative environment, e.g., pair programming) activity. The recording component 208 also allows playback of the recorded activity for reviewing during the session or in an offline environment. For example, if during a session a user needs to direct attention to another matter, once the user comes back, the user can playback all or a portion of the session up to the latest activity. All or a portion of the session activities can be played back at any desired speed by any of the session participants or non-participants at a later time. In this same context, there can be functionality related to the typical recording and playback of other types of information, for example, pause, rewind, fast-forward, reverse, fast-reverse, tagging and skipping to only tagged parts of the session record, and so on.

The system 200 can also include a mapping component 210 for manually and/or automatically mapping user identifiers (IDs) from one system to another. For example, a user ID in text messaging could be different than a user ID for a source control system. The mapping component 210 supports the automatic presence detection of a user by the presence component 104. For example, when examining the collaboration history, the status of users who committed the change is found through mapping their source control IDs to their collaboration IDs. Rather than calling the user, which is a viable albeit rudimentary option, the mapping component 210 can be configured to receive and store potential participant IDs and/or obtain such IDs from other enterprise systems.

The IDs can be user login information (e.g., username, password), device IDs, email address, network IP addresses for user devices, user aliases, user geolocation information, phone numbers, and so on. In any case, the mapping component 210 will provide the mapping between the user IDs of the available system/devices, and automatically present a presence indicator to a user about the availability of another user. One common way is to present a user icon that is pronounced (for the user being online) or grayed out (for the user being identifiable but offline). The user ID can be utilized during the collaborative session by tagging user participation activity with the ID. Thus, later access by the user or other users can be reviewed to see who the previous participants were and where the user activity occurred. Such IDs can also be used to perform searches of all collaboration activity based on the tagged activity and thereafter provide a consolidated report of the user contributions for a collaboration process, for example.

The system 200 can also employ an inference component 212, which can employ machine learning and reasoning (LR) to facilitate automating one or more features based on learned and reason patterns of activity and data. The subject architecture (e.g., in connection with selection) can employ various LR-based schemes for carrying out various aspects thereof. The inference component 212 can access collected data, which can reside locally or remotely (e.g., on a server).

A classifier is a function that maps an input attribute vector, x=(x1, x2, x3, x4, xn), to a class label class(x). The classifier can also output a confidence that the input belongs to a class, that is, f(x)=confidence (class(x)). Such classification can employ a probabilistic and/or other statistical analysis (e.g., one factoring into the analysis utilities and costs to maximize the expected value to one or more people) to prognose or infer an action that a user desires to be automatically performed.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, for example, various forms of statistical regression, naive Bayes, Bayesian networks, decision trees, neural networks, fuzzy logic models, and other statistical classification models representing different patterns of independence can be employed. Classification as used herein also is inclusive of methods used to assign rank and/or priority.

As will be readily appreciated from the subject specification, the subject architecture can employ classifiers that are explicitly trained (e.g., via a generic training data) as well as implicitly trained (e.g., via observing user behavior, receiving extrinsic information, or relevance feedback). For example, SVM's are configured via a learning or training phase within a classifier constructor and feature selection module. Thus, the classifier(s) can be employed to automatically learn and perform a number of functions according to predetermined criteria.

Inferencing can be applied to many different aspects described herein. This can be based on user activities, user profiles, user machine capabilities, connectivity capabilities, expertise related to activities during the session, contacts information, and so on. For example, the system 200 can capture the messaging content by one or more of the session participants in a context. At a later time the system 200 could extract and present this information to other participants performing related work on the session topics.

Another example of inferencing involves detecting and reporting architectural coupling, poor partitioning of concerns, or components with too many responsibilities, all from the amount and/or patterns of communication between team members.

This can also include project management types of information where a project manager would like to see the level or state of progress on a certain topic or activity, or the amount of time spent on developing artifacts. This session information could provide man-hours spent and on what work (e.g., artifacts), what artifacts generated the most or least collaborative work, what artifacts are the product of solo work and thus likely to need additional reviews, and so on.

User capabilities can be classified based on the amount of work on certain projects or topics. For example, a person who works on a similar piece of code for awhile could be classified as an expert in that area. When another user is having a problem in that area, the contact information for the “expert” can be retrieved and presented, suggesting that person as a potential collaborator. This can also be employed to determine not only who will be the driver, but how long a user will be a driver. For example, a more experienced user can drive longer than a less experienced user. Alternatively, a less experienced user can drive longer to obtain the training. This also applies to debugging, testing or browsing. If a user gets stuck, a collateral ad hoc collaborative session can be created with a user who may have the solution.

Another example related to inferencing involves inferring from the type of artifact that users work on to make recommendations on how the user could swap roles and in what areas of the project the users can be brought to resolve problems or for training. Inferencing can also be applied to prepare other users for upcoming projects by reasoning that those users could be brought in as navigators on a current project that uses similar programming to what will be used in the latter session for the other users. This aids in filling holes in the knowledge that may exist for some users and recommending training.

The system 200 can also include an adapter component 214 for interfacing to and obtaining functionality provided by an external program, for example, instant messaging systems. Thus, existing enterprise services, third-party plug-ins or components tailored to specific collaboration contexts can be loaded to augment the native capabilities of the collaborative environment to support other types of communication capabilities and collaborations.

Another plug-in can facilitate finding buddies or others to pair or multi-party with, such as domain experts. Another pluggable module can facilitate showing user expertise and inter-social skills for pairing together. In another example, if certain team members tend to spend too much time discussing a session topic, this can raise a flag, in response to which an administrator can be alerted to intercede and get the project moving or find a resource that will overcome the problem.

The distributed multi-party architecture is language independent as well as application independent. In other words, programming and session interaction can include editing in, for example, C# files, Visual Basic files, XML files, graphical widgets, etc. It is to be understood, however, that visual cues such as distributed highlighting could be configured to be presented differently if viewing text versus graphical widgets, and so on.

The disclosed architecture is extensible and scales to a wide range of collaborative environments. For example, it is possible in a collaborative environment, that there can be four participants working together in a session where the driver has three different applications open within the collaborative environment and each of those three different applications is independently working with the one of other three users. In other words, there can be multiple sessions with multiple applications by multiple distributed parties where visual cues are different per application, per user, and per session, for example.

As a general, but non-exhaustive implementation, the system 200 can provide a combination of the following capabilities and functionality:

manual and/or automatic role control and turn-taking: for example, a chess clock-like control (toggle) for switching between a programming driver (the user whose editor is in active mode and making the edits) and the navigator (the user whose editor is in passive mode and watching the driver);

multiple cursors (destructive and non-destructive): for example, extending the IDE editor with a palette of cursors from which the navigator can pick and choose;

distributed highlighting or other types of visual cues: for example, the navigator can use these cues to highlight elements on the driver's screen without interfering with the selection in the active editor;

decaying edit trails: for example, the most-recently edited lines are marked graphically (e.g., using color, glyphs, etc.) and the markings decay (e.g., reduce in color intensity) based on certain criteria (e.g., over time or change) allowing one user (or developer) to catch up quickly with the other user's edits;

view convergence and divergence: for example, the driver and navigator environments can be synchronized to show the same content, or the navigator can chose to diverge from the content state of the driver and work on a different artifact;

easy access to history of edits: for example, log the changes enacted during the pair programming session such that both programmers have access to the changes made, at a user-defined granularity (e.g., when collaborating on code, granularity can be at class or method or line of code level); and

language-independent event model where the IDE can send activity notifications for multiple languages (e.g., C#, XML, VB, C++, etc.): for example, the programmers can use pair programming features in any supported language.

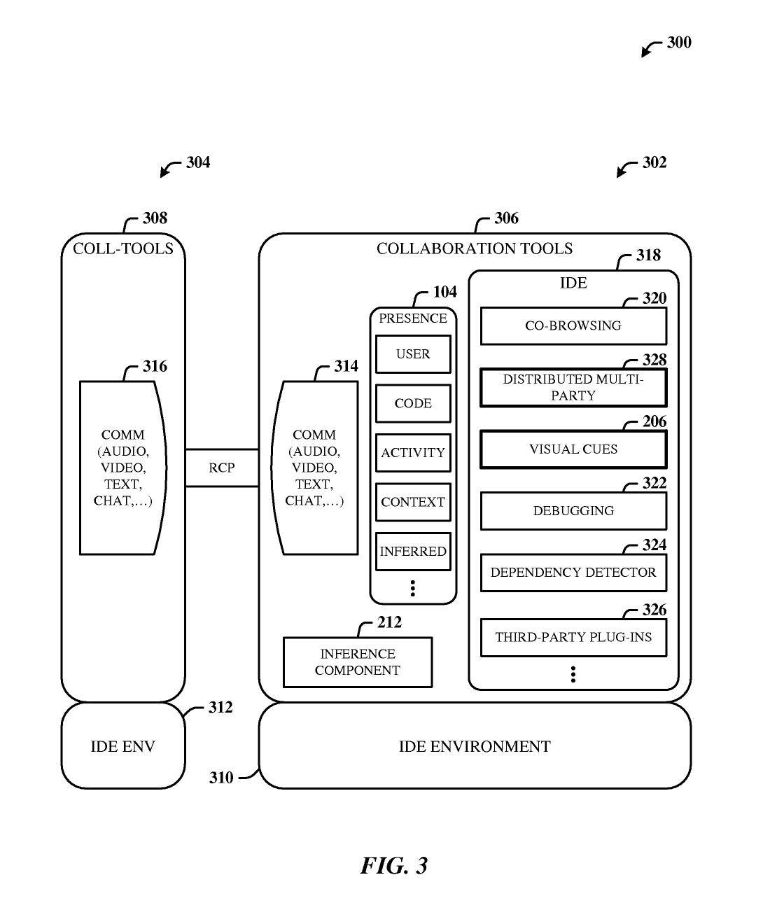

FIG. 3 illustrates an implementation of an exemplary system 300 in the context of a collaboration environment. The system 300 shows a head-to-head scenario of two user systems in collaboration: a first user system 302 in collaborative communication with a second user system 304. Each user system (302 or 304) employs respective collaboration tools (306 or 308) that work in combination with (or enhance) corresponding IDE environments (310 or 312). The collaboration tools (306 and 308) of the user systems (302 and 304) communicate using realtime communications platform (RCP) via respective communications components (314 and 316), similar to capabilities of the communications component 106 of FIG. 1. As previously indicated, communications can occur by chat, text messaging, audio communications, video communications, code, application sharing, or any combination thereof.

This exemplary implementation uses a peer-to-peer configuration; an alternative client-server scenario connects the participants through a server rather than directly to each other. The RCP channel is how communication flows through the network between the drivers and navigators. However, this is just one example of a protocol that can be employed. For example, if a word processing application is employed the protocol could be different.

Operating as a layer over the IDE environment 310, the tools 306 of the first user system 302 include the set of communication tools 314, the presence component 104 for augmenting the collaborative experience with the capability to indicate what users are in the collaborative environment, what users are available to be involved in the session, what artifact is being worked on, the activity of the user relative to the artifact, and so on. The presence component 104 facilitates realtime presence (e.g., user, code, activity, etc.), contextual presence, and inferred presence. Realtime presence refers to the presence information about the parties that the user explicitly configured for collaborative work, such as those in their buddy list. For example, the user needs to know whether the person with whom they are pair programming is editing, debugging, or engaged in a chat session with someone else. Contextual presence refers to presence information about parties that the user may want to collaborate with. Rather than being configured explicitly, this set of users is determined from current or past user contexts such as version control system, directory services, etc. Realtime and/or contextual presence can also include if the user is in an audio conversation with someone else (in the session or not).

Inferred presence refers to presence information about parties suggested by the system as potential collaborators. For example, if a user heavily communicated when working on a artifact, it can be inferred that the user should or could be looped in when discussion about that artifact occurs, or in the future when similar development occurs for which the user could provide a benefit. Inferred presence can also include bringing novice users or developers into the session based on a need to learn, watch or participate based on a lack of knowledge. These are just a few examples of realtime, contextual, and inferred presence. The communications tools 314 compensate for the participants being distributed by providing the communications capabilities to interact with other session collaborators in various ways.

The collaborative tools 306 of the first user system 302 provide IDE functionality 318 for the IDE in the form of co-browsing 320 the same artifacts together, debugging 322 and configuring dependencies via a dependency detector 324. For example, users can be linked to receive the same information when generated or communicated. The tools 306 also provide for third-party plug-ins, as well as other functionality, as desired.

The tools 306 provide distributed multi-party collaborative support via the multi-party component 328 and visual cues via the visual component 206 (such as turn-taking and visual cues) are shown with a thick border.

The tools 306 can also include the inference component 212. A similar set of tools 308 is provided for the second user system 304.

Following is an example of a distributed pair programming scenario in accordance with the disclosed distributed multi-party software construction architecture. User A right clicks on user B in a collaboration tools window and selects “Start remote pair programming session.” User B is presented based on presence information detecting that user B is available. Upon user B accepting the session A becomes the driver and B the navigator.

User B's display changes to show the code that user A is working on. The code view is locked (convergence) so that both users are looking at the same code. User A (the driver) then starts writing code. The text entered in the code window by user A shows up in user B's code window (the navigator or reviewer). User B's code window shows the regular cursor (which A controls). User B can also pick one of several colored cursors and highlight areas of the code in the code window. These highlights show up in user A's window. However, the highlighting is non-destructive and does not interfere with the regular cursor operations (e.g., cut, paste, etc.).

The users then switch roles so user B can drive while user A watches as the navigator (or reviewer). To do this, user B announces (e.g., via person-to-person speech, or RCP communications means) the intention to switch roles, and then toggles a radio button (e.g., similar to the function associated with the pushbutton on an old-fashioned chess clock). This switches the control over the main cursors and keyboard to user B while user A's highlighters become active. As user B edits the code, the two code views remain in sync (convergence) so that both users (A and B) are looking at the same code. At the end of the session, user A checks the code into a source control system.

At any time during the session, either user A or user B can initiate and use one or more of the unified channels of communication (e.g., audio, video conferencing, instant messaging, and application sharing to share any other application). This can also include sidebar conversations with other user by departing briefly from the ongoing session (divergence). This way the users can communicate with each other in the same manner as if using the same machine at the same desk. At any time, either the driver (now user B) or navigator (now user A) can see a history of the edits. Additionally, at any time, only the driver can edit the code while the navigator's code is locked.

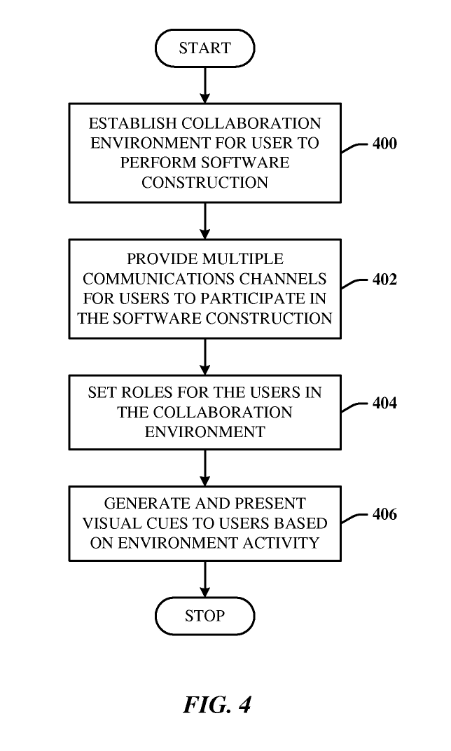

FIG. 4 illustrates a computer-implemented method of multi-party software construction. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

At 400, a collaborative environment is created in which users perform collaborative software construction. At 402, multiple different communication channels are provided by which the users participate in the software construction. At 404, roles are set for the users in the collaborative environment. At 406, visual cues are generated and presented to the users based on environment activity.

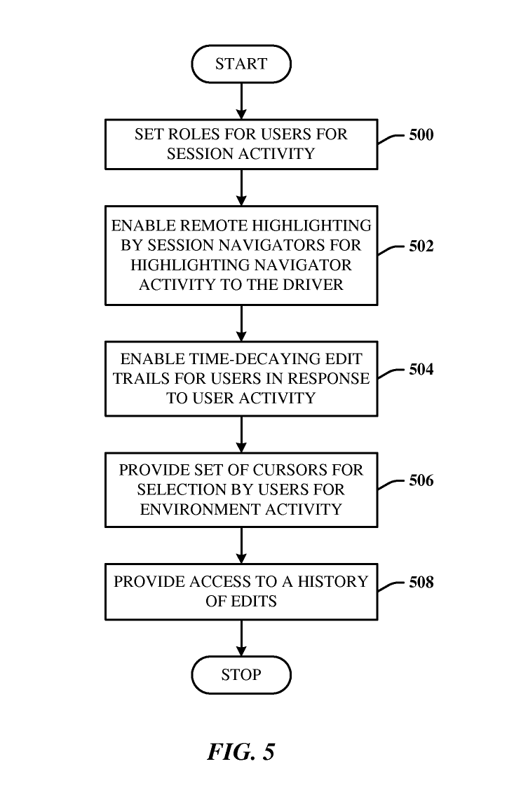

FIG. 5 illustrates a method of employing visual cues in a collaborative environment for software construction. At 500, user roles are set for the session. At 502, remote highlighting is enabled for session navigators for highlighting navigator activity to the driver. At 504, time-decaying edit trail is enabled for session users in response to user activity. At 506, a set of cursors is provided and selectable by session users for environment activity. At 508, access to a history of edits can be provided.

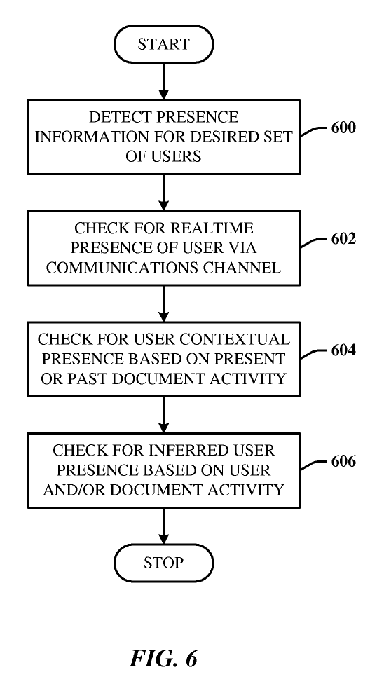

FIG. 6 illustrates a method of processing presence information for collaboration participants. At 600, the system detects presence information for desired set of users. At 602, the systems checks for realtime presence of users via the unified communications channel. At 604, the system checks for contextual presence based on current or past document activity. At 606, the system checks for inferred presence based on user and/or document activity.

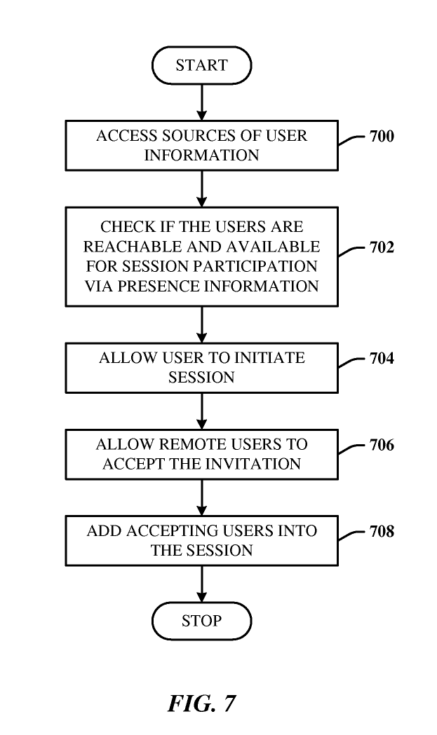

FIG. 7 illustrates a method of connecting to session users for presence determination. At 700, sources of user information are accessed. At 702, the system checks if the users are reachable and available for session participation via presence information. At 704, a user is allowed to initiate a session. At 706, remote users are allowed to accept the invitation. At 708, the users that accepted are added into the session for collaboration.

While certain ways of displaying information to users are shown and described with respect to certain figures as screenshots, those skilled in the relevant art will recognize that various other alternatives can be employed. The terms “screen,” “screenshot”, “cursor,” “document”, and “artifact” are generally used interchangeably herein.

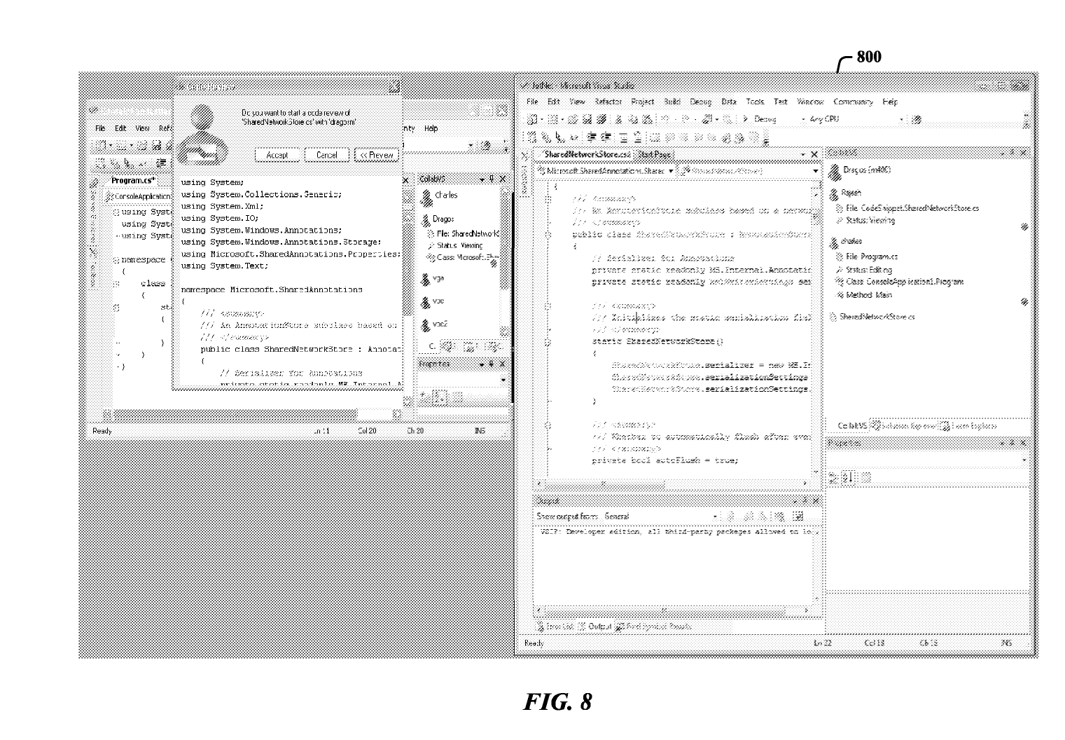

FIG. 8 shows a screenshot 800 for code review within a collaborative software construction environment. The screenshot 800 shows two development environments belonging to two users: a first user on the right and a second user on the left. From the opened file, the user on the right initiated a code review session and selected a third user Charles (who is online) as a reviewer. Charles is then prompted about it.

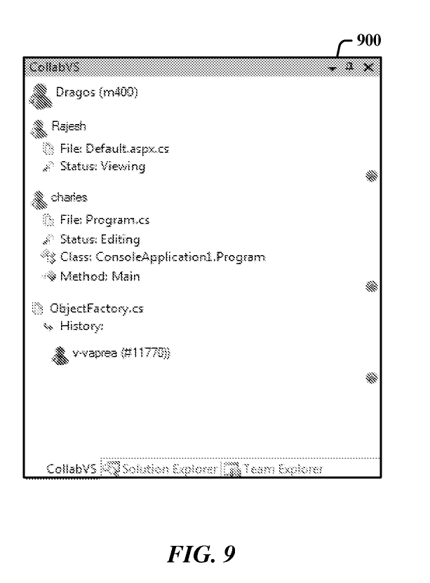

FIG. 9 shows a screenshot 900 of presence information. Icons or other suitable graphical indicia can be provided for quick viewing and understanding of the user presence. For example, realtime presence information can be represented by icons: one icon can indicate online, and another icon for offline. Additionally, the file information, artifact being worked on and status can be provided as part of the presence information. Here, Rajesh is viewing a file, and Dragos is editing a file with a class and method. Contextual information is provided where a file ObjectFactory.cs has been edited by v-vaprea who is currently offline.

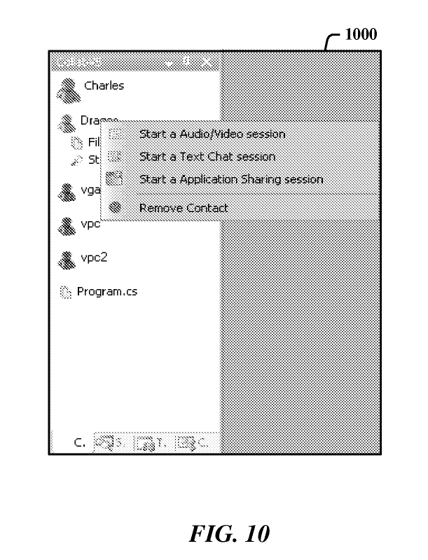

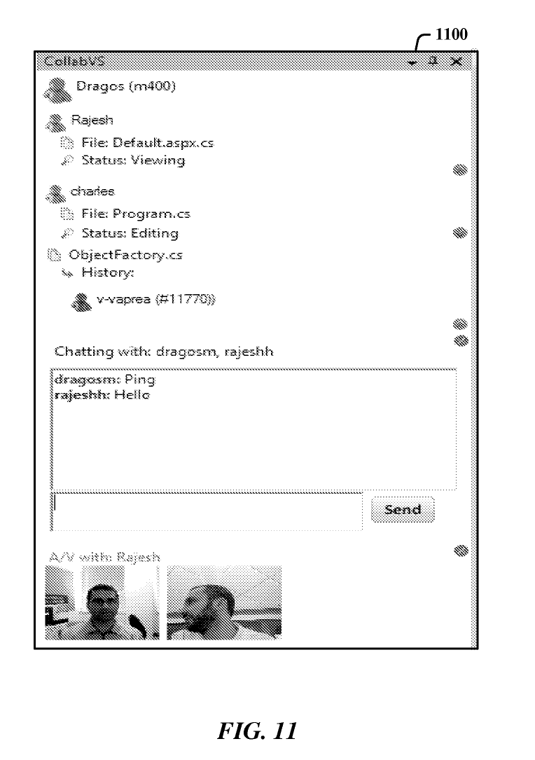

FIG. 10 shows a screenshot 1000 for establishing communications with a user, and a collaboration feature (e.g., application sharing) being only one click away, as well as text, chat, and audio/video actions. FIG. 11 shows a screenshot 1100 of a communications chat session as well as audio/video communications between the session participants.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

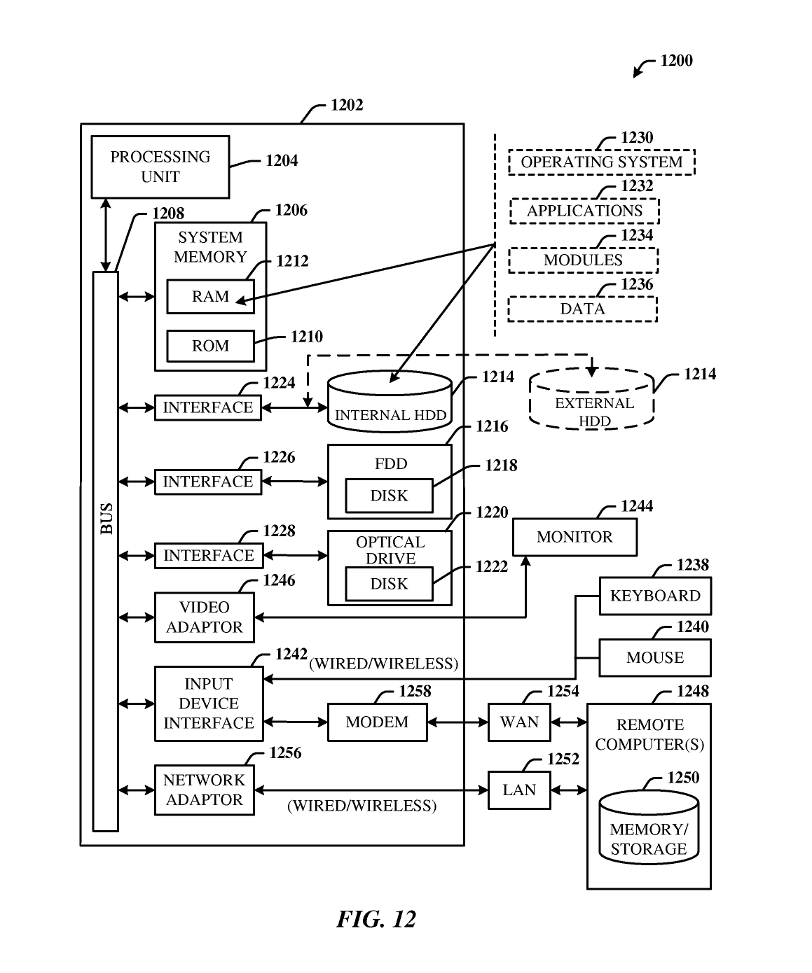

Referring now to FIG. 12, there is illustrated a block diagram of a computing system 1200 operable to execute collaborative software construction in accordance with the disclosed architecture. In order to provide additional context for various aspects thereof, FIG. 12 and the following discussion are intended to provide a brief, general description of a suitable computing system 1200 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 12, the exemplary computing system 1200 for implementing various aspects includes a computer 1202, the computer 1202 including a processing unit 1204, a system memory 1206 and a system bus 1208. The system bus 1208 provides an interface for system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies.

The drives and associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 1212, including an operating system 1230, one or more application programs 1232, other program modules 1234 and program data 1236. The one or more application programs 1232, other program modules 1234 and program data 1236 can include the components described herein in the system 100 of FIG. 1, the system 200 of FIG. 2, and the system 300 of FIG. 3, for example.

All or portions of the operating system, applications, modules, and/or data can also be cached in the RAM 1212. It is to be appreciated that the disclosed architecture can be implemented with various commercially available operating systems or combinations of operating systems.

A user can enter commands and information into the computer 1202 through one or more wire/wireless input devices, for example, a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wire and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wire/wireless connectivity to a local area network (LAN) 1252 and/or larger networks, for example, a wide area network (WAN) 1254. Such LAN and WAN networking environments are commonplace in offices and companies, and facilitate enterprise-wide computer networks, such as intranets, all of which may connect to a global communications network, for example, the Internet.

When used in a LAN networking environment, the computer 1202 is connected to the local network 1252 through a wire and/or wireless communication network interface or adapter 1256. The adaptor 1256 may facilitate wire or wireless communication to the LAN 1252, which may also include a wireless access point disposed thereon for communicating with the wireless adaptor 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wire and/or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, for example, computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wire Ethernet networks used in many offices.

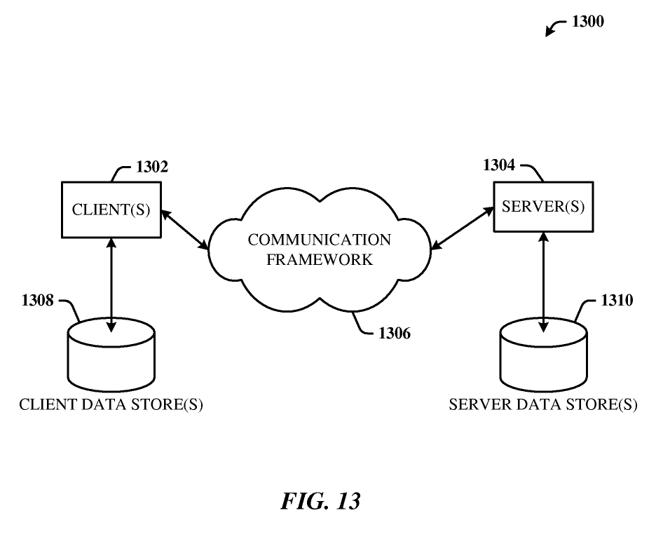

Referring now to FIG. 13, there is illustrated a schematic block diagram of an exemplary computing environment 1300 for collaborative programming. The system 1300 includes one or more client(s) 1302. The client(s) 1302 can be hardware and/or software (e.g., threads, processes, computing devices). The client(s) 1302 can house cookie(s) and/or associated contextual information, for example.

The system 1300 also includes one or more server(s) 1304. The server(s) 1304 can also be hardware and/or software (e.g., threads, processes, computing devices). The servers 1304 can house threads to perform transformations by employing the architecture, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wire (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

The clients 1302 can be included as part of the systems and devices 204 of FIG. 2. The user systems 302 and 304 can be clients 1302 for example.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for collaborative work, comprising:
a collaboration component for establishing a collaboration environment in which to perform software construction;
a presence component for generating presence information related to availability of a user to participate in the collaboration environment; and
a communications component for providing multiple different communication channels by which the user can participate in the collaboration environment.

2. The system of claim 1, wherein the presence information is at least one of realtime, contextual, or inferred.

3. The system of claim 1, wherein the software construction is associated with at least one of development, test, debugging, or review.

4. The system of claim 3, wherein the at least one of development, test, debugging, or review occurs via at least one of a collocated environment or a distributed environment.

5. The system of claim 1, wherein multi-party distributed software construction is performed via the collaboration environment.

6. The system of claim 1, further comprising a role component for switching roles between participants during a construction activity, in which one or more of the participants are designated as driver participants that can make changes and remaining participants are designated navigator participants for view-only capability.

7. The system of claim 1, further comprising a recording component for recording environment activity and playing back the recorded activity.

8. The system of claim 1, further comprising a visual component for generating and presenting a decaying edit trail of an edit during the software construction.

9. The system of claim 1, wherein the multiple different communication channels facilitate at least one of text messaging, audio communications, application sharing, code sharing, co-editing, or video communications.

10. The system of claim 1, further comprising a machine learning and reasoning component that employs a probabilistic and/or statistical-based analysis to prognose or infer an action that is desired to be automatically performed.

11. A computer-implemented method of multi-party software construction, comprising:
creating a collaboration environment in which users perform software construction;
providing multiple different communication channels by which the users participate in the software construction;
setting roles for the users in the collaboration environment; and
generating and presenting visual cues to the users based on environment activity.

12. The method of claim 11, further comprising switching between the roles automatically or manually.

13. The method of claim 11, further comprising enabling remote highlighting as part of the environment activity.

14. The method of claim 11, further comprising establishing a pair-programming session based on one of an intentional pairing of the users or an ad-hoc pairing of the users.

15. The method of claim 11, further comprising generating and communicating activity notifications in multiple program languages.

16. The method of claim 11, further comprising converging or diverging views for participating users.

17. The method of claim 11, further comprising presenting a decaying edit trail in response to user activity.

18. The method of claim 11, further comprising inferring user presence based on disparate sources of information associated with a user.

19. The method of claim 11, further comprising presenting multiple cursors from which one or more cursors can be selected by the users for the environment activity.

20. A computer-implemented system, comprising:
computer-implemented means for creating a collaboration environment in which users perform collaborative software construction;
computer-implemented means for providing multiple different communication channels by which the users participate in the software construction;
computer-implemented means for setting roles for the users in the collaboration environment; and
computer-implemented means for generating and presenting visual cues to the users based on environment activity.
